(19) United States
(12) Patent Application Publication
(10) Pub. No.: US 2025/0260246 A1
(43) Pub. Date: Aug. 14, 2025

(54) CONTROL UNIT FOR CONTROLLING THE POWER OF AT LEAST ONE BATTERY, AIRCRAFT COMPRISING SAID CONTROL UNIT, AND CORRESPONDING CONTROL METHOD

(71) Applicant: SAFRAN ELECTRICAL & POWER, BLAGNAC (FR)

(72) Inventors: Franck BAQUE, MOISSY-CRAMAYEL (FR); Quentin CORNU, MOISSY-CRAMAYEL (FR); Fabrice GUERIN, MOISSY-CRAMAYEL (FR); Guillaume PERCHERON, MOISSY-CRAMAYEL (FR); Alexis RENOTTE, MOISSY-CRAMAYEL (FR)

(73) Assignee: SAFRAN ELECTRICAL & POWER, BLAGNAC (FR)

(21) Appl. No.: 18/836,307

(22) PCT Filed: Feb. 1, 2023
(86) PCT No.: PCT/FR2023/050132

§ 371 Date: Aug. 6, 2024

(30) Foreign Application Priority Data
Feb. 7, 2022 (FR) FR2201055

(51) Int. Cl. H02J 7/00

(52) U.S. Cl. CPC H02J 7/00304; H02J 7/0031; H02J 7/0047; H02J 2310/44

(57) ABSTRACT

A control unit for controlling the power of a battery including at first and second incoming connections carrying a DC voltage and first and second outgoing connections delivering a DC voltage. The first incoming connection is connected to a first current sensor and to a high-voltage busbar via a protection member. The high-voltage busbar is connected to the first outgoing connection via a first controlled fuse and a second current sensor, and to a second outgoing connection via a second controlled fuse and a third current sensor. A control means is configured to switch the protection member, the first controlled fuse or the second controlled fuse based on received measurements so as to isolate an electrical fault.

### TECHNICAL FIELD

The technical field of the invention is the electrical protection of aircraft power supply networks, and more specifically, the protection of high-voltage DC power supply networks.

### PRIOR ART

Electrical networks on board an aircraft generally comprise either the combination of an AC voltage network (115Vac or 230Vac) and a low-voltage DC network (28Vdc), or a single DC voltage network (28Vdc).

Aircraft operating on an AC network have a total onboard electrical power comprised between 50 and 500 kW (or even 1 MW) while purely low-voltage DC networks (LVDC) have more limited onboard power levels of less than 100 kW.

To date, there is no high-voltage DC network for aircraft. Therefore, there are no components enabling operation at a voltage of 800 VDC and power levels of around 100 to 250 kW. Such networks would be advantageous for electrically powered aircraft.

The trend towards a high-voltage DC power supply network on the one hand, and towards electrical energy sources made up of batteries on the other hand, means that conventional protection solutions (mainly of I²t type FIG. 1) cannot be used. Indeed, the transient current profiles are different for high-voltage DC than for high-voltage AC. The energy levels and associated dynamics are completely different to those found in high-voltage AC networks.

The protection and selectivity strategy of type I²t, which is well suited to a rotating machine, is therefore no longer relevant. Moreover, the sizing of this protection for AC networks depends on the conductors of the power supply network and the winding of the rotating machine. Capacitive sources make this sizing of the type I²t protection unsuitable.

Capacitive sources, such as high-power batteries, can be subject to incidents unknown to rotating machines, resulting in thermal runaway or very high-power short-circuit currents.

When the battery heats up excessively beyond a certain temperature, it is subject to a phenomenon known as thermal runaway, which might ultimately lead to overpressure and the release of gases. This overheating can be caused by excessive current when the battery is overcharged or short-circuited.

Short-circuit currents developed by such batteries (in particular with Li-Ion technology) can reach values of several thousand amperes as a result of a very quick increase shortly after the short-circuit occurs. It is therefore difficult to interrupt such high currents with a very short increase time in a reasonable space and weight compatible with an aircraft.

The object of the invention is therefore to overcome the drawbacks of the prior art and in particular the limitations outlined above, relating to the protection of high-voltage DC electrical networks for aircraft.

The following documents are known from the prior art.

Document EP 3 703 220 A1 describes the regulation of the voltage supplied by an active rectifier in order to be able to connect it to a battery.

Document EP 3 588 729 B1, document EP 2 980 946 B1 and document FR 3 050 882 describe conventional electrical networks designed to power the onboard network of an aircraft.

Document WO 2020/174165 A1 and document FR 3 098 663 describe the architecture of an electric propulsion system but do not disclose any protection or distribution boxes.

Document EP 3 683 911 A1 describes a fault protection method applied to interconnected high-voltage DC networks (HVDC).

None of these documents provides a solution to the technical issue identified above.

### DISCLOSURE OF THE INVENTION

One object of the invention is a battery power management unit comprising at least two incoming connections carrying a DC voltage and two outgoing connections delivering a DC voltage, a first incoming connection being connected to a first current sensor and to a high-voltage busbar via a protection member, the high-voltage busbar being connected to a first outgoing connection via a first controlled fuse and a second current sensor, and to a second outgoing connection via a second controlled fuse and a third current sensor, the management unit further comprising a control means designed to switch at least one out of the protection member, the first controlled fuse and the second controlled fuse based on measurements received from the first current sensor, the second current sensor or the third current sensor so as to isolate an electrical fault in the management unit, at least one of the incoming connections or at least one of the outgoing connections.

The management unit can comprise a first contactor and a second incoming connection, the first contactor being connected on the one hand to the first current sensor and on the other hand to the protection member, the second incoming connection being connected to the first contactor via a second contactor connected to the control means.

The management unit can comprise a third incoming connection connected to a third contactor via a fourth current sensor, the third contactor being connected to the high-voltage busbar, the third contactor and the fourth current sensor being connected to the control means.

A secondary busbar can be arranged between a current sensor and the corresponding contactor or the corresponding controlled fuse.

Another object of the invention is an aircraft provided with a battery and two electric motors, comprising a battery power management unit as described above, wherein the first incoming connection is connected to the battery, the first outgoing connection being connected to the first electric motor, the second outgoing connection being connected to the second electric motor.

The aircraft can comprise an emergency power supply and/or be connected to a stationary recharging means, wherein the second incoming connection is connected to the stationary recharging means and the third incoming connection is connected to the emergency power supply.

The aircraft can comprise two battery power management unit connected in parallel via their third incoming connections.

The aircraft can comprise two battery power management units connected in parallel by their second incoming connection, each battery power management unit comprising a link between their high-voltage busbar and the first outgoing connection and the second outgoing connection of the other battery power management unit, each link being provided with a second protection member controlled by the control means.

Finally, another object of the invention is a management method for an electrical power management unit arranged in an aircraft as described above, the management method comprising the following steps:
to power the electric motor via the battery, the first contactor is controlled so that it is made conductive while the second contactor and the third contactor are controlled so that they are made non-conductive,
to power the electric motor via the emergency power supply, the third contactor is controlled so that it is made conductive while the first contactor and the second contactor are controlled so that they are made non-conductive, and
to charge the battery via the auxiliary power unit, the second contactor is controlled so that it is made conductive while the first contractor and the third contactor are controlled so that they are made non-conductive.

When a fault is detected in the power supply to an electric motor or group of electric motors supplied by one of the outgoing connections via the protection member, the following steps can be carried out:
the protection member is commanded to open in order to interrupt the current flowing from the battery, prevent the establishment of a short-circuit current and avoid thermal runaway of the battery,
a fault message is sent from the protection member to the control means,
an opening command is sent from the control means to the first contactor in order to physically isolate the battery,
the location of the fault is determined based on measurements from the first current sensor, the second current sensor, the third current sensor and the fourth current sensor via the control means,
an activation command is sent from the control means to the first controlled fuse,
after the first controlled fuse has tripped, a close command is sent from the control means to the first contactor and to the protection member in order to restore power to the other electric motor.

When a fault is detected in the high-voltage busbar, the following steps can be carried out:
the protection member is commanded to open in order to interrupt the current flowing from the battery, prevent the establishment of a short-circuit current and avoid thermal runaway of the battery,
a fault message is sent from the protection member to the control means,
an opening command is sent from the control means to the first contactor in order to physically isolate the battery,
the measurements are compared from the first current sensor, the second current sensor, the third current sensor and the fourth current sensor via the control means, and
a power supply fault information message is sent depending on the result of the comparison.

When a fault is detected in the battery via the control means based on the measurements from the first current sensor and/or the protection member, the following steps can be carried out:
an opening command is sent from the control means to the first contactor in order to physically isolate the battery,
an opening command is sent from the control means to the protection member,
a close command is sent from the control means to the third contactor in order to restore power to the electric motors,
a pre-charge sequence is initiated on the emergency power supply in order to charge the capacitors of the electric motors, and
once the capacitors have been charged, the main line is activated.

When a fault is detected in the emergency power supply via the control means based on the measurements from the fourth current sensor, the following steps can be carried out:
an opening command is sent from the control means to the third contactor in order to physically isolate the emergency power supply, and
a power supply redundancy fault notification is sent from the control means.

### BRIEF DESCRIPTION OF THE DRAWINGS

Other aims, features and advantages of the invention will appear upon reading the following description, given solely as a non-limiting example and made with reference to the appended drawings wherein:

FIG. 1 shows the main elements of a battery power management unit according to the invention,

FIG. 2 shows the main steps of a management method for such a management unit, and

FIG. 3 shows the main elements of an alternative embodiment of a battery power management unit according to the invention.

### DETAILED DESCRIPTION

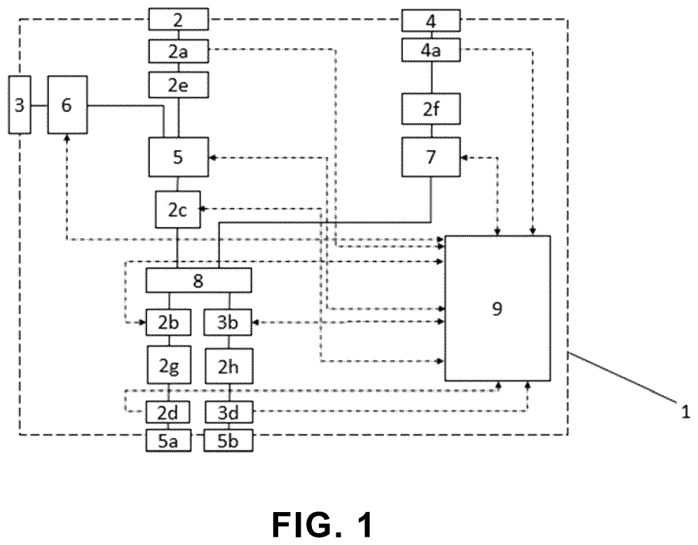

In order to solve the technical issue, a battery power management unit (BPMU) is proposed. The battery power management unit BPMU is identified with reference numeral 1 in FIG. 1.

The battery power management unit 1 comprises three incoming connections 2, 3, 4 carrying a DC voltage and two outgoing connections 5a, 5b delivering a likewise DC voltage.

A first incoming connection 2 can be connected to a battery.

A second incoming connection 3 can be connected to a stationary recharging means, such as an auxiliary power unit or APU.

A third incoming connection 4 can be connected to an emergency power supply.

A first outgoing connection 5a can be connected to a first electric motor or group of electric motors.

A second outgoing connection 5b can be connected to a second electric motor or group of electric motors.

The first incoming connection 2 is connected to a first current sensor 2a which is itself connected to a first contactor 5. The output of the first contactor 5 is connected to a high-voltage busbar 8 via a protection member 2c SSPC (Solid State Power Controller). The protection member 2c is designed to limit the current flowing through its terminals and to enable pre-charging when power is supplied. When the protection member closes, the potential difference (high-voltage battery upstream and zero voltage downstream) results in a current close to the levels of the short-circuit current. In order to avoid this, the protection member 2c is fitted with a current limiter enabling a gradual voltage increase and thus preventing the establishment of a short-circuit current.

The second incoming connection 3 is connected to a second contactor 6, which is itself connected to the input of the first contactor 5 in parallel with the first current sensor 2a.

The high-voltage busbar 8 is connected at the output to the first outgoing connection 5a to a first electric motor via a first controlled fuse 2b and a second sensor 2d, and to the second outgoing connection 5b via a second controlled fuse 3b and a third sensor 3d.

The first controlled fuse 2b and the second controlled fuse 3b respectively isolate the first electric motor and the second electric motor in the event of a distribution fault.

The third incoming connection 4 is connected to a fourth current sensor 4a which is itself connected to a third contactor 7. The output of the third contactor 7 is connected to the high-voltage busbar 8.

The first current sensor 2a, the second current sensor 2d, the third current sensor 3d and the fourth current sensor 4a are able to measure current flowing between their terminals.

The second current sensor 2d, the third current sensor 3d and the fourth current sensor 4a are also able to detect the formation of series and/or parallel electric arcs.

The battery power management unit 1 also comprises a control means 9 designed to control the first contactor 5, the second contactor 6 and the third contactor 7, the protection member 2c SSPC, the first controlled fuse 2b and the second controlled fuse 3b based on measurements received from the current sensors 2a, 4a, 2d, 3d and the state of the protection member 2c SSPC.

In one particular embodiment, the battery power management unit BPMU comprises secondary busbars 2e, 2f, 2g, 2h at the output of the first sensor 2a, the second sensor 2d and at the input of the third sensor 3d and the fourth sensor 4a. These secondary busbars 2e, 2f, 2g, 2h enable a plurality of power supply elements (batteries, emergency power supplies) or a plurality of powered elements (a plurality of electric motors) to be connected in parallel by multiplying the various connections.

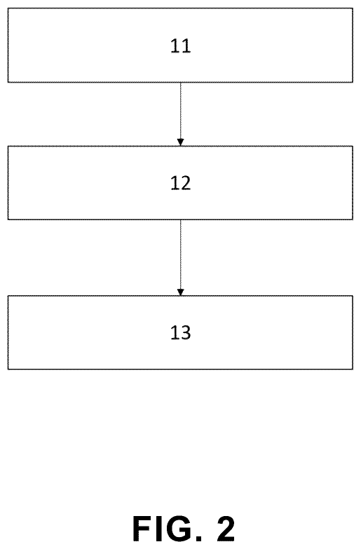

The main steps of the management method according to the invention will now be described and are shown in FIG. 2.

To power the electric motor via the battery, during a first step 11, the first contactor 5 is made conductive while the second contactor 6 and the third contactor 7 are made non-conductive.

To power the electric motor via the emergency power supply, during a second step 12, the third contactor 7 is made conductive while the first contactor 5 and the second contactor 6 are made non-conductive.

To charge the battery using the auxiliary power unit, during a third step 13, the second contactor 6 is made conductive while the first contactor 5 and the third contactor 7 are made non-conductive.

The management method also comprises steps when a fault occurs in the power supply to the electric motors, such as a short-circuit or overvoltage.

During a first sub-step, a fault is detected via the protection member 2c SSPC and the protection member 2c SSPC is commanded to open in order to interrupt the current flowing from the battery, prevent the establishment of a short-circuit current and avoid thermal runaway of the battery. A fault message is sent from the protection member 2c SSPC to the control means 9.

During a second sub-step, an opening command is sent from the control means 9 to the first contactor 5 in order to physically isolate the battery.

During a third sub-step, the location of the fault is determined based on measurements from the first current sensor 2a, the second current sensor 2d, the third current sensor 3d and the fourth current sensor 4a via the control means 9.

During a fourth sub-step, an activation command is sent from the control means 9 to the first controlled fuse 2b. The analysis and comparison of the currents via the current sensors 2d, 3d and 2a enable the location of the fault causing a short-circuit to be identified. The control means 9 then actuates the switching element closest to the fault.

During a fifth sub-step, after the first controlled fuse 2b has tripped, a close command is sent from the control means 9 to the first contactor 5 and to the protection member 2c SSPC in order to restore power to the other electric motor.

The management method also comprises steps when a fault occurs, such as a short-circuit or overvoltage on the busbar 8.

During a first sub-step, a fault is detected via the protection member 2c SSPC and the protection member 2c SSPC is commanded to open in order to interrupt the current flowing from the battery, prevent the establishment of a short-circuit current and avoid thermal runaway of the battery. A fault message is sent from the protection member 2c SSPC to the control means 9.

During a second sub-step, an opening command is sent from the control means 9 to the first contactor 5 in order to physically isolate the battery.

During a third sub-step, the measurements are compared from the first current sensor 2a, the second current sensor 2d, the third current sensor 3d and the fourth current sensor 4a via the control means 9 in order to determine the location of the fault. If the comparison of the measurements does not allow for the location of the fault to be determined, it is assumed that the fault has occurred at the busbar 8.

During a fourth sub-step, a power supply fault information message is sent.

The management method also comprises steps when a fault occurs, such as a short-circuit or overvoltage in the battery.

During a first sub-step, a fault is detected in the battery via the control means 9 based on the measurements from the first current sensor 2a and/or the protection member 2c SSPC. Such a fault is characterised, for example, by zero current.

During a second sub-step, an opening command is sent from the control means 9 to the first contactor 5 in order to physically isolate the battery and an opening command is sent from the control means 9 to the protection member 2c SSPC.

During a third sub-step, a close command is sent from the control means 9 to the third contactor 7 in order to restore power to the electric motors.

During a fourth sub-step, a pre-charge sequence is initiated on the emergency power supply in order to charge the capacitors of the electric motors. Once the capacitors have been charged, the main line is activated. In order to guarantee the quality of the electrical network, capacitors are placed at various points in the battery power management unit (electric motor, at the output of the protection member SSPC 2c). In order to avoid a sudden connection of these capacitors to the voltage of the backup battery when the member 7 is switched, a pre-charge sequence (which limits the current passing through the switching member 7) is activated and increases the voltage of said capacitors in order to equalise the upstream and downstream voltages. Once the upstream and downstream voltages are equal, the pre-charge sequence is terminated and the main line that provides the required power to the motor is activated.

The management method also comprises steps when a fault occurs, such as a short-circuit or overvoltage in the emergency power supply.

During a first sub-step, a fault is detected in the emergency power supply via the control means 9 based on the measurements from the fourth current sensor 4a. Such a fault is characterised, for example, by zero current.

During a second sub-step, an opening command is sent from the control means 9 to the third contactor 7 in order to physically isolate the emergency power supply

During a third sub-step, a power supply redundancy fault notification is sent from the control means 9.

The battery power management unit BPMU and the corresponding management method make it possible to detect, protect against and isolate faults that may occur in the battery power management unit BPMU or at its periphery in order to both prevent them from spreading and ensure continuity of operation of the power supply to the motor(s).

The detection and switching elements chosen protect against electrical faults without using conventional I²t type methods that do not effectively protect a network powered by high-voltage DC batteries.

In one particular embodiment, two battery power management units BPMU can be combined together via their emergency power supply so as to increase the number of electric motors powered. More specifically, the emergency power supply of a first battery power management unit BPMU 1a is connected to the emergency power supply of a second battery power management unit BPMU 1b. If the battery powering one or other of the battery power management units BPMU has a fault, power can be provided by the other battery power management unit BPMU.

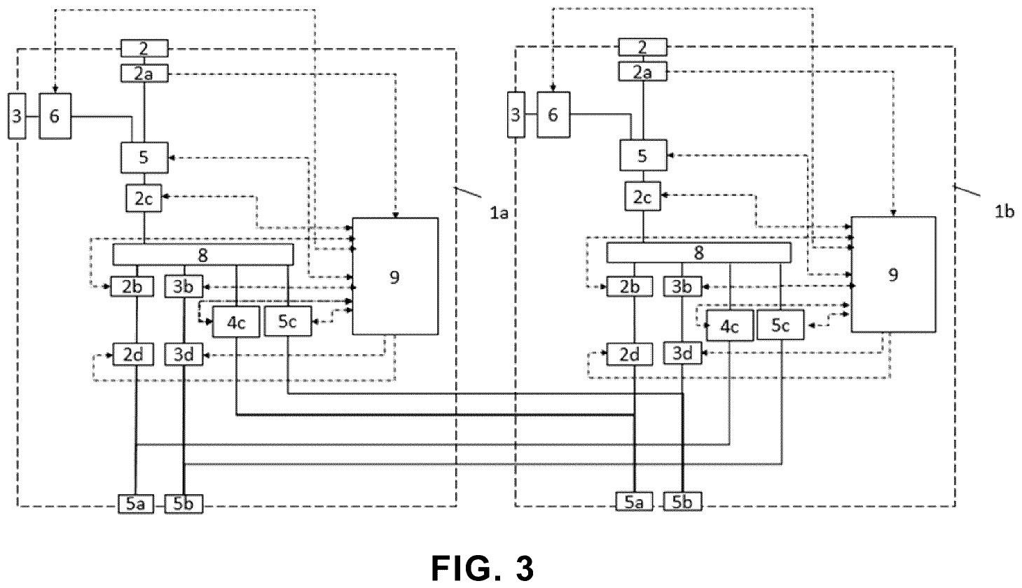

In another embodiment shown in FIG. 3, two battery power management units BPMU 1a, 1b are combined together via their emergency power supply so as to increase the number of electric motors powered. However, unlike the battery power management units BPMU according to the other embodiments, the emergency power supply of a battery power management unit BPMU 1a, 1b is connected downstream of the high-voltage bus 8, the emergency power supplies of one battery power management unit BPMU being directly connected to the electric motors powered by the other battery power management unit BPMU so as to be able to power them in the event of a fault. Each power supply for an electric motor is therefore provided with a second protection member SSPC 4c, 5c controlled by the control means 9.

Furthermore, the battery powering each battery power management unit BPMU can be connected in parallel to each battery power management unit BPMU so as to be able to help power the electric motors in the event of an internal fault in a battery power management unit BPMU.

1. An aircraft provided with a battery and two electric motors, comprising a battery power management unit comprising at least first and second incoming connections carrying a DC voltage and first and second outgoing connections delivering a DC voltage, the first incoming connection being connected to a first current sensor and to a high-voltage busbar via a protection member, the high-voltage busbar being connected to the first outgoing connection via a first controlled fuse and a second current sensor, and to the second outgoing connection via a second controlled fuse and a third current sensor, the first incoming connection being connected to the battery, the first outgoing connection being connected to a first electric motor, the second outgoing connection being connected to a second electric motor, the management unit further comprising a control means designed to switch at least one out of the protection member, the first controlled fuse and the second controlled fuse based on measurements received from the first current sensor, the second current sensor or the third current sensor so as to isolate an electrical fault in the management unit, at least one of the first and second incoming connections or at least one of the first and second outgoing connections, the management unit comprising a first contactor connected on the one hand to the first current sensor and on the other hand to the protection member, the second incoming connection being connected to the first contactor via a second contactor connected to the control means, the management unit comprising a third incoming connection connected to a third contactor via a fourth current sensor, the third contactor being connected to the high-voltage busbar, the third contactor and the fourth current sensor being connected to the control means.

2. The aircraft according to claim 1, wherein the management unit comprises a secondary busbar arranged between a current sensor and the corresponding contactor or the corresponding controlled fuse.

3. The aircraft according claim 1, further comprising an emergency power supply and/or being connected to a stationary recharging means, wherein the second incoming connection is connected to the stationary recharging means and the third incoming connection is connected to the emergency power supply.

4. The aircraft according to claim 3, further comprising two battery power management units connected in parallel via the third incoming connections.

5. The aircraft according to claim 3, further comprising two battery power management units connected in parallel by the second incoming connection, each battery power management unit comprising a link between the high-voltage busbar and the first outgoing connection and the second outgoing connection of the other battery power management unit, each link being provided with a second protection member controlled by the control means.

6. A management method for an electrical power management unit arranged in the aircraft according to claim 1, the management method comprising the following steps:
powering the electric motor via the battery, the first contactor is controlled so that it is made conductive while the second contactor and the third contactor are controlled so that they are made non-conductive,
powering the electric motor via the emergency power supply, the third contactor is controlled to be made conductive while the first contactor and the second contactor are controlled to be made non-conductive, and
charging the battery via the auxiliary power unit, the second contactor is controlled to be made conductive while the first contactor and the third contactor are controlled to be made non-conductive.

7. The management method according to claim 6, wherein, when a fault is detected in the power supply to an electric motor or group of electric motors supplied by one of the outgoing connections via the protection member, the following steps are carried out:
commanding the protection member to open in order to interrupt the current flowing from the battery, prevent the establishment of a short-circuit current and avoid thermal runaway of the battery,
sending a fault message from the protection member to the control means,
sending an opening command from the control means to the first contactor in order to physically isolate the battery,
determining the location of the fault based on measurements from the first current sensor, the second current sensor, the third current sensor and the fourth current sensor via the control means,
sending an activation command from the control means to the first controlled fuse, and
after the first controlled fuse has tripped, sending a close command from the control means to the first contactor and to the protection member in order to restore power to the other electric motor.

8. The management method according to claim 6, wherein, when a fault is detected in the high-voltage busbar, the following steps are carried out:
commanding the protection member to open in order to interrupt the current flowing from the battery, prevent the establishment of a short-circuit current and avoid thermal runaway of the battery,
sending a fault message from the protection member to the control means,
sending an opening command from the control means to the first contactor in order to physically isolate the battery,
comparing the measurements from the first current sensor, the second current sensor, the third current sensor and the fourth current sensor via the control means, and
sending a power supply fault information message depending on the result of the comparison.

9. The management method according to claim 6, wherein, when a fault is detected in the battery via the control means based on the measurements from the first current sensor and/or the protection member, the following steps are carried out:
sending an opening command from the control means to the first contactor in order to physically isolate the battery,
sending an opening command from the control means to the protection member,
sending a close command from the control means to the third contactor in order to restore power to the electric motors,
initiating a pre-charge sequence on the emergency power supply in order to charge the capacitors of the electric motors, and
once the capacitors have been charged, activating the main line.

10. The management method according to claim 6, wherein, when a fault is detected in the emergency power supply via the control means based on the measurements from the fourth current sensor, the following steps are carried out:
sending an opening command from the control means to the third contactor in order to physically isolate the emergency power supply, and
sending a power supply redundancy fault notification from the control means.
